(19) United States
(12) Patent Application Publication
(10) Pub. No.: US 2012/0284662 A1
(43) Pub. Date: Nov. 8, 2012

(54) VIRTUALIZED CACHING OF USER INTERFACE CONTROLS

(75) Inventors: Dileep R. P. Kumar, Redmond, WA (US); Joseph W. Hallock, Renton, WA (US); Michal Nowak, Bellevue, WA (US); Keeron G. Modi, Redmond, WA (US)

(73) Assignee: Microsoft Corporation, Redmond, WA (US)

(21) Appl. No.: 13/100,304

(22) Filed: May 4, 2011

(51) Int. Cl. G06F 3/048

(52) U.S. Cl. 715/781

(57) ABSTRACT

One or more visible user interface controls from a cache can be displayed. The user interface controls can also include one or more virtualized controls and one or more partially visible controls. In response to an indication to move in a dimension, one or more displays of visible user interface control(s) can be changed, and a control can be virtualized in the cache. Also, in response to the indication to move, one or more of the user interface controls in the cache can be recycled by performing population (i.e., populating the control) with data from outside the subset of data items in the data set. Additionally, an indication to change the number of controls in the data set can be received, and in response, the number of controls in the cache can be changed.

### BACKGROUND

User interface displays can be used to navigate large amounts of data, with the data being represented as visual elements on the displays. The visual elements on a display can be constructed by generating user interface controls, populating those user interface controls with data, and painting the populated controls onto the display (i.e., actually displaying the controls). The user interface controls that are being used may be kept in a cache in memory.

When navigating the data, users can provide user input for navigation. For example, a user may request drilling down into levels, drilling up out of levels, movement of the visual elements in different directions such as right, left, up, down, etc. In response, new user interface controls may be created and populated so that the new controls can be painted onto the display, as requested by the user input. Variations on this technique have also been used, such as virtualization of the user interface controls. As used herein, virtualization of user interface controls refers to the controls being created and populated with data before the controls reach a viewport, which is a portion of the set of user interface controls that is currently being displayed.

### SUMMARY

Navigation through user interface controls can be improved using one or more of various tools and techniques described herein, either alone or in combination. For example, these tools and techniques may include pixel-based virtualization of user interface controls. Pixel-based virtualization refers to displaying the user interface controls and/or bringing virtualized controls into the viewport on the basis of pixels (although the pixel values may be translated into other values as part of the positioning, such as translating the pixel values into pixel groups (e.g., groups of 3 pixels), inches, centimeters, etc.). This can allow virtualized controls to be brought partially within the viewport so that they can be partially displayed. As used herein, virtualized controls are controls that have been virtualized and are not yet even partially visible or within the viewport. Partially visible controls are virtualized controls that are partially visible on the display and partially within the viewport in the cache. The tools and techniques may also include adaptive recycling of user interface controls. Adaptive recycling of controls includes reusing controls from the cache when new controls are to be virtualized, and changing the number of controls in the cache (such as by creating new controls in the cache or discarding controls from the cache) when the number of controls to be maintained in the cache changes.

In one embodiment, the tools and techniques can include maintaining a cache of user interface controls, which can correspond to a subset of data items from a data set. One or more visible user interface controls from a viewport in the cache can be displayed on a pixel basis. The user interface controls in the cache can also include one or more virtualized invisible user interface controls and one or more partially visible user interface controls. The technique can include receiving an indication to move in a dimension. In response to the indication, the technique can include changing one or more displays of visible user interface control(s) on the display; determining whether a control is to be virtualized in the cache in response to the indication; and if so, then virtualizing a control in the cache.

In another embodiment of the tools and techniques, a cache of user interface controls can be maintained, with the controls corresponding to a subset of data items from a data set. One or more visible user interface controls from a viewport in the cache can be displayed. The controls in the cache can also include one or more virtualized user interface controls. The technique can include receiving an indication to move in a dimension. In response to the indication, one or more of the user interface controls in the cache can be recycled by performing population (i.e., populating the control) with data from outside the subset of data items in the data set. Additionally, an indication to change the number of controls in the data set can be received, and in response, the number of controls in the cache can be changed.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is schematic diagram of a user interface control caching environment.

FIG. 3 is a flowchart of a user interface control virtualized caching technique.

FIG. 4 is a flowchart of another user interface control virtualized caching technique.

FIG. 5 is a flowchart of yet another user interface control virtualized caching technique.

### DETAILED DESCRIPTION

Embodiments described herein are directed to techniques and tools for improved display of visual elements. Such improvements may result from the use of various techniques and tools separately or in combination.

Such techniques and tools may include smooth scrolling of user interface controls that have been virtualized, where user interface controls that have been virtualized may be partially in view, and partially virtualized. As used herein, smoothly scrolling refers to scrolling in a finer manner than jumping from one control to another. For example, scrolling may be done on a pixel bases, such as pixel-by-pixel (one pixel at a time, such as one pixel column and/or row at a time). Alternatively, smooth scrolling may be done on a pixel basis with larger groups of pixels, such as two pixel columns and/or rows at a time, three pixel columns and/or rows at a time, etc. The techniques and tools may also include adaptive caching of recyclable user interface controls, where the number of user interface controls in a cache can be changed. For example, this change may be done in response to an indication, such as an indication to change how many user interface controls are in the viewport and/or how many virtualized user interface controls are to be maintained in a cache.

The user interface controls being navigated may represent data in a data set, and movement in different dimensions may represent movement in corresponding dimensions in the data set. For example, the data set may be a file system that includes current and historical copies of files, folders, etc. Movement to the left and right can represent movement forward and backward in time. Additionally, drilling down, such as drilling down into a file folder, can represent movement further into the data set Likewise, drilling up, such as drilling up out of a file folder, can represent movement out of levels in the data set. Many other types of data sets may be navigated, such as database tables, sets of web pages, etc.

These techniques and tools may be used alone, together with each other and/or with other techniques and tools herein to produce one or more benefits such as improved user interface performance. For example, these tools and techniques can be used with a user interface system to navigate large amounts of visual elements representing a set of data without using a proportionate amount of resources on a computer system. However, the subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware implementations, such as application specific integrated circuits, programmable logic arrays and other hardware devices, can be constructed to implement at least a portion of one or more of the techniques described herein. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

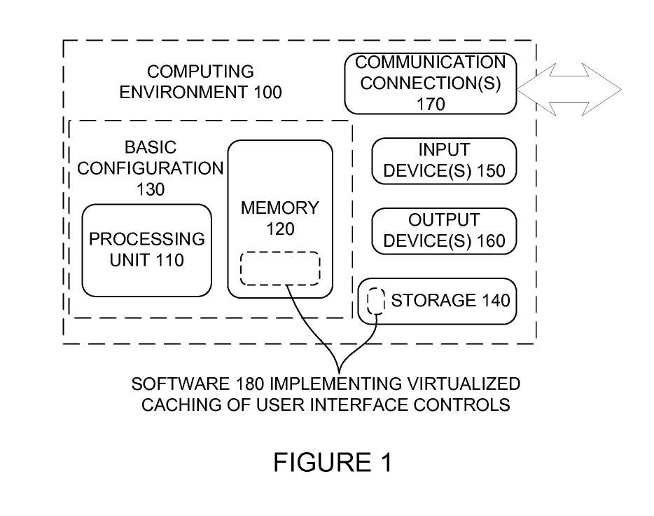

FIG. 1 illustrates a generalized example of a suitable computing environment (100) in which one or more of the described embodiments may be implemented. For example, one or more such computing environments can be used as a system for virtualized caching of user interface controls. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices (e.g., smart phones, tablets, etc.), game consoles multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and at least one memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The at least one memory (120) may be volatile memory (e.g., registers, cache, RAM), non-volatile memory (e.g., ROM, EEPROM, flash memory), or some combination of the two. The at least one memory (120) stores software (180) implementing virtualized caching of user interface controls.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. User Interface Control Virtualized Caching System and Environment

A. General Environment

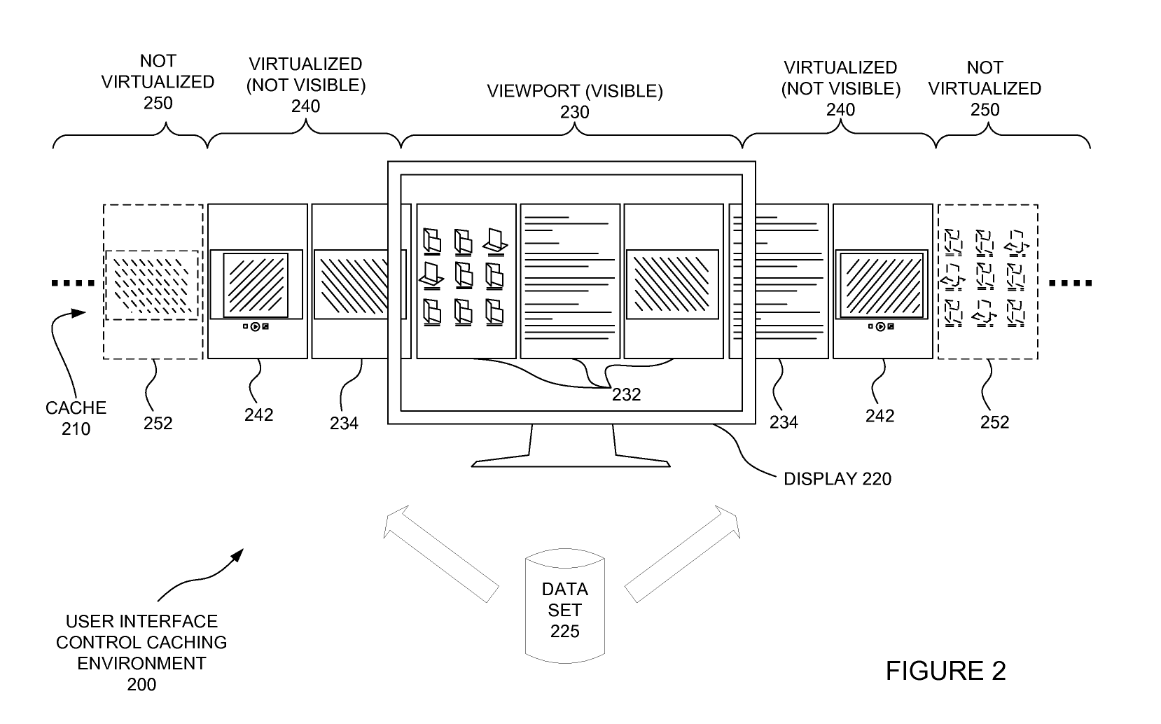

FIG. 2 is a block diagram of a user interface control virtualized caching environment (200) in conjunction with which one or more of the described embodiments may be implemented. The environment (200) can include a cache (210) of user interface controls to be displayed on a computer display (220). The controls can be populated with data from a data set (225), and the environment (200) can respond to user input by navigating through the controls representing the data set (225).

The user interface controls of the cache (210) can be considered to be split into two main portions: a visible portion, or viewport (230), that includes fully visible controls (232) and visible portions of partially visible controls (234); and a virtualized portion (240) that is not visible but includes controls that have been created and populated, including virtualized controls (242) and virtualized portions of partially visible controls (234). FIG. 2 also illustrates an additional not-yet-virtualized portion (250) of controls (252) that are not yet virtualized in the cache (210).

B. Pixel-Based Virtualization of Controls

Pixel-based virtualization can allow a partially visible control (234) to be partially in the viewport (230) and still be able to perform virtualization of controls. This can allow a user interface to have smooth scrolling of the controls on the display, and at the same time allow virtualization of controls.

Virtualization of controls includes creating a control (242) in the cache (210) and populating the control (242) with data before the control (242) is in the viewport. Because the creation and population is done ahead of time, when the virtualized control (242) reaches the viewport (230), the control can be painted on the display (220) more quickly than if the creation and population were done after an indication was received to move the control into the viewport. The painting of the controls on the display may be done using existing techniques and tools, such as the techniques and tools used by operating systems such as a Microsoft Windows® operating system or some other operating system.

As an example, each control (242, 234, and 242) in the cache (210) can be based on a base-type control. In just one example in a Microsoft Windows® operating system environment, the base-type control can be a window with a handle. The control can be virtualized by creating the control (242) in the cache (210) and populated the control (242) with data from the data set (225) before the control is in the viewport (230). Different controls can be populated with different types of data, which can result in the controls having different types of user interface elements. For example, the cache (210) can include controls (232, 234, 242) containing representations of files and file folders, as well as different types of controls for previewing different types of content, such as different types of controls for previewing still images, videos, word processing documents, word processing spreadsheets, slide presentations, web pages, etc.

The environment (200) may allow the data set (225) to be navigated by navigating the representative user interface controls for the data set. The environment (200) can allow such navigation in multiple dimensions. For example, an indication may be received (e.g., from user input from a mouse, keyboard, touch screen, voice control, or other input device) to move the controls in the viewport (230) to the right or left. Such moves can result in content of the partially visible controls (234) coming into or out of view. As the navigation continues, the next control (252) that is not virtualized may be virtualized before reaching the viewport (230). For example, such virtualizations may be performed to maintain a constant number of virtualized controls (242) (which could be a constant number of fully virtualized controls (242) counting any partially visible (and partially virtualized) controls (234) or not counting any partially visible controls (234)) on each side of the viewport (230).

The controls (232, 234, and 242) in the cache (210) can be pixel-based controls. For example, all the controls (232, 234, and 242) may have a known width in pixels, such as where all the controls (232, 234, and 242) have the same width in pixels. Additionally, the position of the controls (232, 234) in the viewport (230) can be determined and tracked on the basis of pixels. In one example, an overall pixel offset is maintained, where the overall pixel offset is the number of pixels from the first control that represents a beginning of the controls representing at least a portion of the data set (225) (e.g., the entire data set, or one level of the data set) to a near edge of the viewport (230). When the controls (232, 234) in the viewport (230) are moved, that overall pixel offset can be adjusted accordingly. In a situation where all the controls (232, 234, 242, and 252) for the data set (225) are the same width, that offset can be calculated by multiplying the pixel width by the number of virtualized controls (242) and not-virtualized controls (252) on that side of the viewport (230), and adding the pixel width of the non-visible portion of the partially visible control (234) (if there is one) on that side of the viewport (230). The positions of the controls (232, 234, and 242) in the cache (210) can be represented as offsets from the overall offset position. As an example, where the user interface controls (232 and 234) in the viewport (230) can be moved to the left or right, the overall pixel offset may be from the left-most user interface control representing the data set (225) to the left-most edge of the viewport (230). The positions of the controls (232, 234, and 242) in the cache (210) can be represented as pixel offsets from the left edge of the viewport (230), with the viewport (230) itself being represented as a pixel range from the left edge. Accordingly, when the controls (232 and 234) are scrolled across the viewport (230), they can be smoothly scrolled across the display (220) with the partially visible controls (234) coming into and out of view in a natural smooth manner (such as one pixel column at a time or in small groups of pixel columns at a time), rather than in a one-control-at-a-time choppy movement.

This smooth scrolling of the controls (232 and 234) across the screen can happen quickly because the controls (242) can be virtualized before reaching the viewport (230). Indeed, several controls (242) may be virtualized on each side of the viewport. Thus, a control can be immediately painted onto the display (220) when an indication is received for the control to reach the viewport (230), because the control has already been virtualized (created in the cache (210) and populated with data).

In addition to or instead of horizontal movement of the controls (232 and 234) on the display (220), the environment (200) may provide for movement in other dimensions. For example, the environment (200) may provide for vertical movement in the same manner as the horizontal movement. The vertical movement could be in addition to or instead of the horizontal movement. As another example, the environment (200) may provide for movement into and out of different levels of a data structure. For example, the environment may allow for drilling into and/or out of file folders in a file system, etc. In that example, when an indication is received to drill down to another level, the cache can represent items in the data set (225) that are at that new level. Likewise, when an indication is received to drill up to another level, the cache can represent items in the data set (225) that are at that new level.

C. Adaptive Recycling of Controls

As discussed above, adaptive recycling of controls includes reusing controls (232, 234, and 242) from the cache (210) when new controls are to be virtualized, and adjusting the number of controls (232, 234, and 242) in the cache (210) by creating new controls in the cache (210) or discarding controls from the cache (210) when the number of controls (232, 234, and 242) to be maintained in the cache (210) changes. For example, an indication to change the number of controls (232, 234, and 242) may be received to change a number of the visible controls (232) and/or to change the number of virtualized controls (242). Such an indication may come from direct user input indicating a number of controls, from an automatic response to a condition (e.g., a change in display size/resolution resulting in more controls being displayed in the viewport, which can result in more controls in the cache), etc. As just one example, the number of virtualized controls (242) may be a fixed number (e.g., one control, two controls, etc.), but user input may be allowed to adjust how many controls (232) are in the viewport (230).

As indicated above, recycling controls involves reusing controls (232, 234, and 242) that are already in the cache (210). To provide an example, scrolling may result in more than the specified number of virtualized controls (242) on the left side of the viewport (230) and less than the specified number of virtualized controls (242) on the right side of the viewport (230). The left-most virtualized control (242) on the left side of the viewport (230) can be recycled as the right-most virtualized control (242) on the right side of the viewport (230). This may be done by keeping the base-type control from the left-most virtualized control (242) and populating it with the data for the next control to be virtualized on the right side. Thus, the new right-most control (242) can be virtualized without actually creating a new control in memory because the base-type control from the left-most control (242) was reused. In addition to reusing the base-type control, one or more of the user interface elements with which the control is populated may be reused. For example, with controls that are providing previews of files, a preview handler may be re-used in some situations, but new preview handlers may be created for each instance in other situations. As an example, the code of the each preview handler may indicate whether or not that type of preview handler can be re-used.

Additionally, the size of the cache (210) can be adapted. For example, if a user input indicates that more user interface controls (232) are to be shown on the display (220) at one time, then more of the user interface controls (232) in the cache (210) will be in the viewport (230). This means that if the same number of virtualized controls (242) is to be maintained on each side of the viewport (230), then the overall number of controls in the cache (210) is to be increased. Accordingly, in this situation one or more new base-type controls can be added to the cache (210) and populated with data from the data set (225), resulting in additional controls (232, 234, and 242) in the cache (210). Additional controls can be added to the cache (210) in a similar manner if user input indicates that more virtualized controls (242) are to be maintained in the cache (210). Moreover, if an indication is received that fewer controls are to be maintained in the cache (210) (such as because fewer visible controls (232) and/or fewer virtualized controls (242) are to be maintained), then some of the right-most and left-most virtualized controls (242) can be discarded from the cache (210). In one implementation, the size of the cache (210) (i.e., number of controls in the cache (210)) can be increased, but the size does not decrease.

This adaptive recycling of cached controls can improve performance because the resource cost of creating new controls can be avoided. Additionally, the adaptive recycling can allow the number of controls in the viewport (230) and/or the number of virtualized controls (242) to be changed, providing flexibility for the cache (210).

D. Recycling of Controls When Drilling Up or Down

As discussed above, the environment (200) can provide for drill-down and/or drill-up dimensions of navigation. These navigations can also involve recycling of controls. If the navigation drills down or up a level (e.g., in response to an indication that user input has selected a file system folder), then the cache (210) can have user interface controls (232, 234, and 242) populated with data from the new level. However, the controls (232, 234, and 242) can be recycled to avoid the resource cost of creating new controls. As with the recycling discussed above, this can include keeping the base-type controls in the cache (210) and populating them with the new data (i.e., data that is not already populating another control in the cache) from the new level in the data set (225). This recycling of controls when drilling up or down can avoid the resource cost of creating new controls for the cache (210) when the navigation changes levels in the data set (225).

### III. User Interface Control Virtualized Caching Techniques

Several user interface control virtualized caching techniques will now be discussed. Each of these techniques can be performed in a computing environment. For example, each technique may be performed in a computer system that includes at least one processor and at least one memory including instructions stored thereon that when executed by the at least one processor cause the at least one processor to perform the technique (one or more memories store instructions (e.g., object code), and when the processor(s) execute(s) those instructions, the processor(s) perform(s) the technique). Similarly, one or more computer-readable storage media may have computer-executable instructions embodied thereon that, when executed by at least one processor, cause the at least one processor to perform the technique.

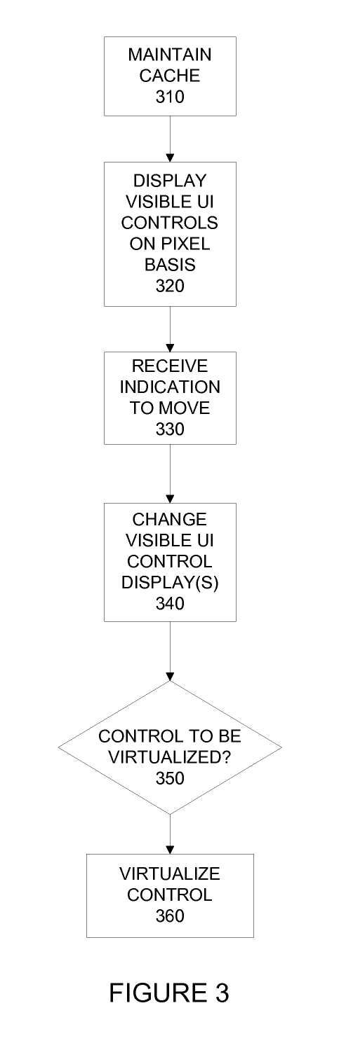

Referring to FIG. 3, a user interface control virtualized caching technique will be described. The technique can include maintaining (310) a cache of user interface controls, with the user interface controls corresponding to a subset of data items that include a portion of data items in a data set. The controls in the cache can include controls of different types. One or more visible user interface controls from a viewport in the cache can be displayed (320) on a display, such as on a pixel bases. The user interface controls in the cache can include one or more virtualized user interface controls and one or more partially visible user interface controls. An indication to move in a dimension can be received (330). In response, one or more displays of one or more of the visible user interface controls can be changed (340) on the display, and the corresponding visible user interface controls can be changed in the viewport. Also in response to the indication, it can be determined (350) whether a control is to be virtualized in the cache in response to the indication to move, and if so, then a control in the cache can be virtualized (360).

Changing (340) display(s) can include calculating one or more positions of one or more visible user interface controls and one or more partially visible user interface controls on a pixel bases. Also, changing (340) display(s) can include smoothly scrolling the visible user interface control(s). Virtualizing (360) a control in the cache can include recycling a control that is already in the cache.

Additionally, the indication to move can include an indication to drill to a new level, such as drilling down to a new level or drilling up to a new level. If so, then changing (340) display(s) of user interface control(s) can include recycling one or more controls in the cache by performing population with data from the new level (i.e., by populating the one or more recycled controls with data from the new level). Moreover, virtualizing (360) a control in the cache can include recycling a control in the cache by performing population with data from the new level.

Still referring to FIG. 3, the technique may include determining whether a number of controls in the cache is to be changed. If so, then the number of controls can be changed. In one example, the technique can include receiving an indication that a number of visible and/or virtual controls in the cache is to change, and responding to the indication by changing the respective number of visible and/or virtual controls in the cache.

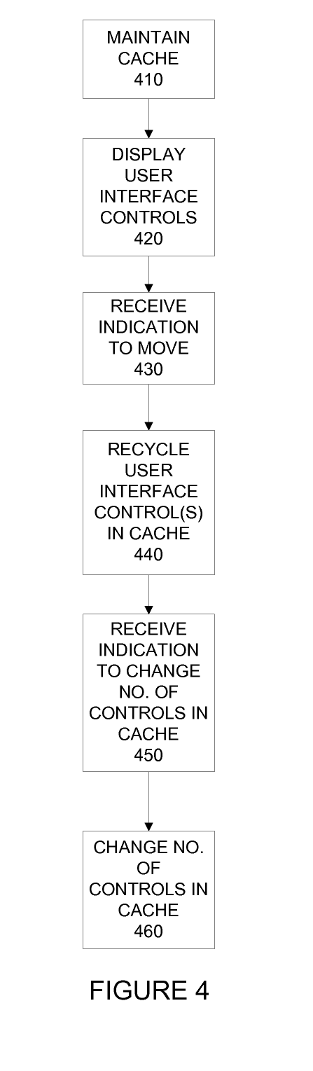

Referring to FIG. 4, another user interface control virtualized caching technique will be described. The technique can include maintaining (410) a cache of user interface controls, the user interface controls corresponding to a subset of data items that comprise a portion of data items in a data set. One or more visible user interface controls from a viewport in the cache can be displayed (420) on a display. The user interface controls in the cache can also include one or more virtualized user interface controls. An indication to move in a dimension can be received (430). In response to the indication to move, one or more user interface controls in the cache can be recycled (440) by populating the control(s) with data from outside the subset of data items in the data set. Additionally, an indication to change a number of controls in the cache can be received (450). In response, the number of controls in the cache can be changed (460).

The technique of FIG. 4 may further include, in response to the indication to move, changing one or more displays of one or more of the visible user interface controls on the display. Additionally, in response to the indication to move, it can be determined whether a control is to be virtualized in the cache, and if so, then a control can be virtualized in the cache. Also in response to the indication to move, one or more positions of one or more visible user interface controls can be calculated on a pixel basis.

The indication to change the number of controls in the cache can include an indication to increase the number of controls in the cache, and changing the number of controls in the cache can include increasing the number of controls in the cache. The indication to change the number of controls in the cache can include an indication that a number of visible and/or virtual controls in the cache is to change, and changing the number of controls in the cache can include changing the respective number of visible and/or virtual controls in the cache.

The user interface controls in the cache may further include one or more partially visible user interface controls, and the technique may further include, in response to the indication to move, smoothly scrolling one or more of the partially visible user interface controls on a pixel basis. Also, the indication to move in a dimension may include an indication to drill down or up in a data structure.

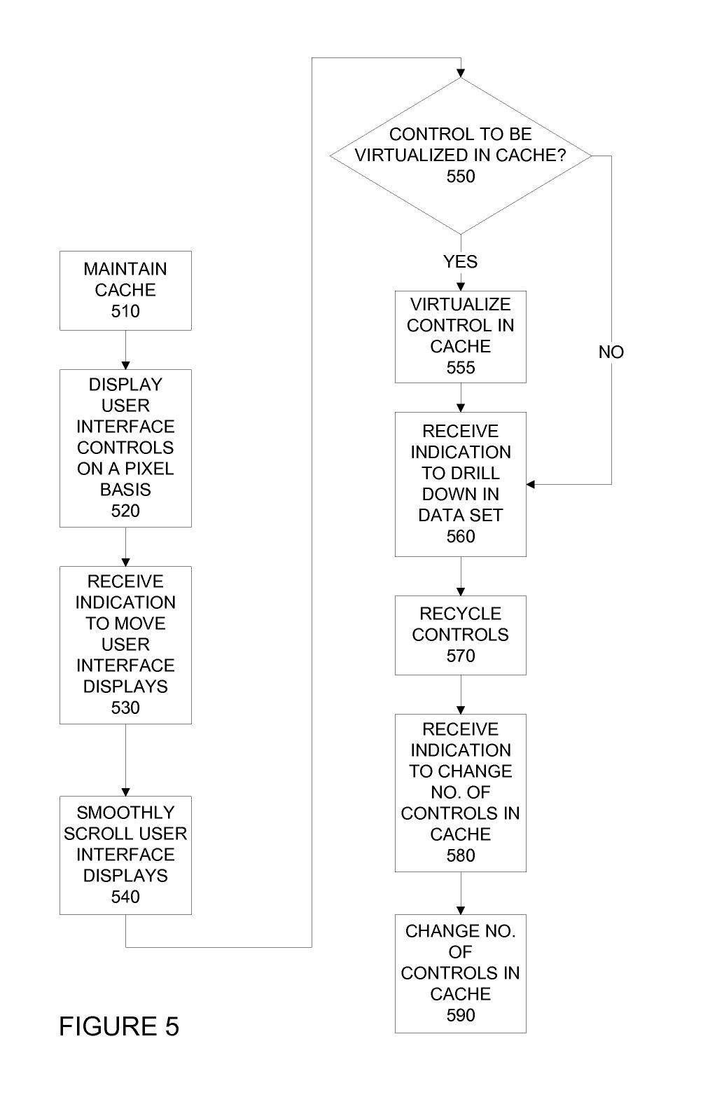

Referring to FIG. 5, yet another user interface control virtualized caching technique will be described. The technique can include maintaining (510) a cache of user interface controls, which correspond to a subset of data items that include a portion of data items in a data set. One or more visible user interface controls from a viewport in the cache can be displayed (520) on a display on a pixel basis. The user interface controls in the cache can also include one or more virtualized invisible user interface controls and one or more partially visible user interface controls.

An indication to move one or more displays of the visible user interface control(s) and one or more displays of the partially visible user interface control(s) in a direction on the display can be received (530). In response to the indication to move in the direction, one or more displays of the visible user interface control(s) and one or more displays of the partially visible control(s) can be smoothly scrolled (540) in the direction on the display. This smooth scrolling (540) can include calculating one or more positions for the control(s) on a pixel basis.

Also in response to the indication to move in the direction, it can be determined (550) whether a control is to be virtualized in the cache in response to the indication to move in the direction. If so, then a control in the cache can be virtualized (555) in the cache, which can include recycling a control already in the cache by performing population with new data (i.e., data that is not already populating another control in the cache). An indication to drill down or up to a new level in a data structure representing the data set can be received (560). In response to the indication to drill, the controls in the cache can be recycled (570) by populating the controls in the cache with new data corresponding to the new level. Moreover, an indication to change a number of controls in the cache can be received (580), and in response, the number of controls in the cache can be changed (590).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer-implemented method, comprising:
maintaining a cache of user interface controls, the user interface controls corresponding to a subset of data items that comprise a portion of data items in a data set;
displaying one or more visible user interface controls from a viewport in the cache on a display on a pixel basis, the user interface controls in the cache also comprising one or more virtualized user interface controls and one or more partially visible user interface controls;
receiving an indication to move in a dimension;
in response to the indication to move:
changing one or more displays of one or more of the visible user interface controls on the display;
determining whether a control is to be virtualized in the cache in response to the indication to move; and
if a control is to be virtualized in the cache in response to the indication to move, then virtualizing a control in the cache.

2. The method of claim 1, wherein changing one or more displays of one or more of the visible user interface controls comprises calculating one or more positions of one or more visible user interface controls and one or more partially visible user interface controls on a pixel basis.

3. The method of claim 1, wherein changing one or more displays of one or more of the visible user interface controls comprises smoothly scrolling the one or more visible user interface controls.

4. The method of claim 1, wherein virtualizing a control in the cache comprises recycling a control that is already in the cache.

5. The method of claim 1, wherein the indication to move comprises an indication to drill to a new level.

6. The method of claim 5, wherein:
changing one or more displays of one or more of the visible user interface controls comprises recycling one or more controls in the cache by performing population with data from the new level; and
virtualizing a control in the cache comprises recycling a control in the cache by performing population with data from the new level.

7. The method of claim 1, further comprising determining whether a number of controls in the cache is to be changed, and if so, then changing the number of controls in the cache.

8. The method of claim 1, further comprising receiving an indication that a number of visible controls in the cache is to change, and responding to the indication that the number of visible controls is to change by changing the number of visible controls in the cache.

9. The method of claim 1, further comprising receiving an indication that a number of virtualized controls in the cache is to change, and responding to the indication that the number of virtualized controls in the cache is to change by changing the number of virtualized controls in the cache.

10. The method of claim 1, wherein the controls in the cache comprise controls of different types.

11. A computer system comprising:
at least one processor; and
at least one memory comprising instructions stored thereon that when executed by the at least one processor cause the at least one processor to perform acts comprising:
maintaining a cache of user interface controls, the user interface controls corresponding to a subset of data items that comprise a portion of data items in a data set;
displaying one or more visible user interface controls from a viewport in the cache on a display, the user interface controls in the cache also comprising one or more virtualized user interface controls;
receiving an indication to move in a dimension;
in response to the indication to move, recycling one or more user interface controls in the cache by populating the one or more user interface controls with data from outside the subset of data items in the data set;
receiving an indication to change a number of controls in the cache; and
in response to the indication to change the number of controls in the cache, changing the number of controls in the cache.

12. The computer system of claim 11, wherein the acts further comprise, in response to the indication to move:
changing one or more displays of one or more of the visible user interface controls on the display;
determining whether a control is to be virtualized in the cache; and
if a control is to be virtualized in the cache in response to the indication to move, then virtualizing a control in the cache.

13. The computer system of claim 11, wherein the acts further comprise, in response to the indication to move, calculating one or more positions of one or more visible user interface controls on a pixel basis.

14. The computer system of claim 11, wherein the indication to change the number of controls in the cache comprises an indication to increase the number of controls in the cache, and changing the number of controls in the cache comprises increasing the number of controls in the cache.

15. The computer system of claim 11, wherein the indication to change the number of controls in the cache comprises an indication that a number of visible controls in the cache is to change, and changing the number of controls in the cache comprises changing the number of visible controls in the cache.

16. The computer system of claim 11, wherein the indication to change the number of controls in the cache comprises an indication that a number of virtualized controls in the cache is to change, and changing the number of controls in the cache comprises changing the number of virtualized controls in the cache.

17. The computer system of claim 11, wherein the user interface controls in the cache further comprise one or more partially visible user interface controls.

18. The computer system of claim 17, wherein the acts further comprise, in response to the indication to move, smoothly scrolling one or more of the partially visible user interface controls on a pixel basis.

19. The computer system of claim 11, wherein the indication to move in the dimension comprises an indication to drill to a new level in a data structure.

20. One or more computer-readable storage media having computer-executable instructions embodied thereon that, when executed by at least one processor, cause the at least one processor to perform acts comprising:
maintaining a cache of user interface controls, the user interface controls corresponding to a subset of data items that comprise a portion of data items in a data set;
displaying one or more visible user interface controls from a viewport in the cache on a display on a pixel basis, the user interface controls in the cache also comprising one or more virtualized invisible user interface controls and one or more partially visible user interface controls;
receiving an indication to move one or more displays of the one or more visible user interface controls and one or more displays of the one or more partially visible user interface controls in a direction on the display;
in response to the indication to move in the direction:
smoothly scrolling one or more of the displays of the one or more visible user interface controls and one or more displays of the one or more partially visible user interface controls in the direction on the display, including calculating one or more positions for one or more of the controls on a pixel basis;
determining whether a control is to be virtualized in the cache in response to the indication to move in the direction; and
if a control is to be virtualized in the cache in response to the indication to move in the direction, then virtualizing a control in the cache, virtualizing a control in the cache comprising recycling a base-type control already in the cache by populating the base-type control with new data;
receiving an indication to drill to a new level in a data structure representing the data set;
in response to the indication to drill to the new level, recycling the controls in the cache by populating the controls in the cache with new data corresponding to the new level;
receiving an indication to change a number of controls in the cache; and
in response to the indication to change the number of controls in the cache, changing the number of controls in the cache.
